(19) United States
(12) Patent Application Publication
(10) Pub. No.: US 2019/0168665 A1
(43) Pub. Date: Jun. 6, 2019

(54) Digital Display Screen Device

(71) Applicant: Karen Wright, Rancho Cucamonga, CA (US)

(72) Inventor: Karen Wright, Rancho Cucamonga, CA (US)

(21) Appl. No.: 16/266,111

(22) Filed: Feb. 4, 2019

Related U.S. Application Data
(63) Continuation-in-part of application No. 15/247,519, filed on Aug. 25, 2016, now abandoned.

(51) Int. Cl. B60Q 1/50; G06F 3/14; G06F 3/023; B60Q 1/52; B60Q 1/26

(52) U.S. Cl. CPC B60Q 1/503; G06F 3/14; B60K 37/06; B60Q 1/52; B60Q 1/268; G06F 3/023

(57) ABSTRACT

A digital display screen device comprises an elliptical housing having an illuminated screen positionable in the rear window of a vehicle, capable of displaying information viewable through the rear window of the vehicle. The information displayed on the screen is a safety indicator or a need for roadside assistance in a critical situation.

### CLAIM OF PRIORITY

This patent application is a continuation-in-part application of and claims priority under 35 USC 119 (e) (1) from U.S. utility patent application Ser. No. 15/247,519, filed Aug. 25, 2016, which in turn claims priority from Provisional Patent Application Ser. No. 62/255,266 filed Nov. 13, 2015, of common inventorship herewith entitled, “The Message Window,” which is incorporated herein by reference as though the same were set forth in its entirety.

### FIELD OF THE INVENTION

The present invention pertains to the field of motor vehicles, and more specifically to the field of safety accessories.

### BACKGROUND OF THE INVENTION

Every year, thousands of Americans find themselves stranded on the side of the highway. Whether a blown tire, a leaking radiator or other mechanical or electronic failure, such vehicular mishaps can occur without a moment's notice and leave a motorist helpless and vulnerable. In addition to annoyance and frustration of car trouble inspires, being stranded can be a frightening and dangerous situation. Particularly, mothers with a carload of small children, young drivers, and elderly motorists often are ill prepared to figure out the mechanical intricacies of a stalled vehicle and lacking in knowledge and equipment to take care of the problem on their own.

Stranded drivers are at the mercy of passing motorists to offer them roadside assistance. Due to increased concerns for personal safety, motorists are much less likely to stop and help a stranded stranger than in the past. While a cellular telephone usually is invaluable in these situations, sometimes break downs occur in an area with no cellular service, or a cell phone loses battery charge and is dead. At this point is necessary to leave one's vehicle to flag down assistance, but many times it is unsafe or impractical to do so if stranded on a major highways, at night, in the cold, or with children in the vehicle. In addition to mechanical failure, a stalled vehicle may contain a motorist who is experiencing a medical emergency. Unable to safely drive, this individual may find himself helpless to alert passing cars that he is in dire need of assistance.

The prior art has put forth several designs for safety accessories. Among these are:

U.S. Pat. No. 7,378,948 to Eddie Somuah describes a digital message display for vehicles that detects a tailgater and automatically flashes a warning message directed to the tailgater. The message displays on an electronic board located in the rear window of the vehicle in view of following traffic. In addition to the warning message directed to the tailgater, a distance display is located in view of the vehicle driver to indicate the distance of the tailgater. An audible alarm alerts the driver to the presence of the tailgater. A wireless remote control device allows the driver to manually select and display one of a number of predefined safety and courtesy messages. Multiple distance sensors provide multiple functional ranges to accommodate varying driving or traffic conditions.

U.S. Pat. No. 6,553,285 to Reslan Bahmad describes a message conveying system for motor vehicles that allows a person operating a vehicle to display one of a plurality of messages to other motorists including a message display adapted for positioning within a motor vehicle adjacent to a rear window thereof. The message display includes an alphanumeric screen disposed therein. The message display includes an internal message memory therein for storing a plurality of alphanumeric messages therein. The internal message memory is in communication with the alphanumeric screen. The message display includes an internal message selection control in communication with the internal message memory. A remote control unit is adapted for securement to a dashboard of the motor vehicle. The remote control unit is in communication with the message display. The remote control unit includes a plurality of message buttons. The message buttons each correspond with one of the plurality of alphanumeric messages of the message display whereby pressing one of the message buttons will allow one of the alphanumeric messages to be displayed on the alphanumeric screen.

U.S. Pat. No. 5,500,638 to Ikoma A. V. George describes a method of communication between vehicle operators. The invention employs common display LEDs, the segments of which, when appropriately turned on, issue desired messages on the reader board for the operators of other vehicles. To issue a message, the operator of a vehicle simply depresses a button on the control box. The operator of a vehicle behind sees the message for a length of time set by a programmable timer.

None of these prior art references describe the present invention.

### SUMMARY OF THE INVENTION

It is an object of the present invention to provide a multifunctional digital display screen that is particularly engineered to be placed in a rear window of an automobile and visibly convey a safety indicator or a need for roadside assistance in a critical situation.

The present invention is a digital display screen device for a vehicle. The vehicle has a rear window. The digital display screen device comprises an elliptical housing positionable in the rear window of the vehicle. An elongated screen is mounted on the housing and viewable through the rear window of the vehicle with the screen displaying information. A control mechanism communicates with the screen for controlling power to and information on the screen. Upon activation of the screen, the information displayed on the screen is a safety indicator or a need for roadside assistance in a critical situation.

In addition, the present invention includes a method for communicating from a vehicle. The vehicle having a rear window. The method comprises positioning a housing in the rear window of the vehicle, mounting an elongated screen on the housing, viewing the screen through the rear window of the vehicle, the screen displaying information, providing a control mechanism, communicating with the screen for controlling power to and information on the screen, and displaying the information on the screen.

The present invention further includes a digital display screen device for a vehicle. The vehicle has a rear window. The digital display screen device comprises a housing positionable in the rear window of the vehicle. An elongated screen is mounted on the housing and viewable through the rear window of the vehicle with the screen displaying a message. A control mechanism communicates with the screen for controlling power to and message on the screen. Upon activation of the screen, the message displayed on the screen is selected to provide a safety indicator or a need for roadside assistance in a critical situation. The message is emblazoned in bright, red block letters flashing across the sign, readable from left to right.

### BRIEF DESCRIPTION OF THE DRAWINGS

FIG. 1 is a perspective view illustrating a digital display screen device, constructed in accordance with the present invention, installed in a vehicle and displaying a message indicating STOP.

FIG. 2 is a perspective view illustrating the digital display screen, constructed in accordance with the present invention, installed in a vehicle and displaying a message indicating U-TURN.

FIG. 3 is a perspective view illustrating an alternative embodiment of the digital display screen device, constructed in accordance with the present invention, installed in a vehicle and displaying a message indicating HOSPITAL.

FIG. 4 is a perspective view illustrating an alternative embodiment of the digital display screen device, constructed in accordance with the present invention, installed in a vehicle and displaying a message indicating STOP.

### DETAILED DESCRIPTION OF THE INVENTION

The present invention, hereinafter referred to as a Digital Display Screen Device 10, is a multifunctional digital display screen that is particularly engineered to be placed in a rear window 12 of an automobile 14. The Digital Display Screen Device 10 provides motorists with a visible means of notifying other cars or emergency personnel that they are experiencing car trouble, have a medical emergency, intend to make a U turn, or various other indicators selected from an assortment of preprogrammed messages. The Digital Display Screen Device 10 is a handy tool that enables stranded motorists to quickly and easily convey their need of roadside assistance. Additionally, the Digital Display Screen Device 10 is easily installed in a vehicle's 14 rear window 12 by replacing the brake light and functions.

The Digital Display Screen Device 10 of the present invention is comprised of an illuminated sign 16 which is easily installed in a vehicle's rear window 12 and functions effectively in relaying information to other drivers on the road. In addition to calls for assistance in an emergency situation or roadside mishap, the Digital Display Screen Device 10 is programmed to relay a variety of other directives aimed at improving safety on the road. Such directives include, but are not limited to, an indication of making a U turn, reverse and caution signs for semi trucks, and notification that a passenger in the vehicle 14 is going to the hospital so traffic will allow the car to pass.

The Digital Display Screen Device 20 is an elongated, elliptical screen 38 that is sized appropriately to fit into the back window of any vehicle 14. In an alternative embodiment, the Digital Display Device 10 is an elongated rectangular screen 18 that is sized to fit into the back of any vehicle 14. The Digital Display Screen Device 10 or 20 is activated by means of voice automation or a simple sensor mechanism integrally located within the sign 16. The sensor mechanism enables a user to operate the Digital Display Screen Device 10 or 20 displays by means of a handheld remote control component. In addition to functioning cordlessly and independently from a distance, the remote control component is also directly connectable to the Digital Display Screen Device 10 or 20 by means of an elongated power cord.

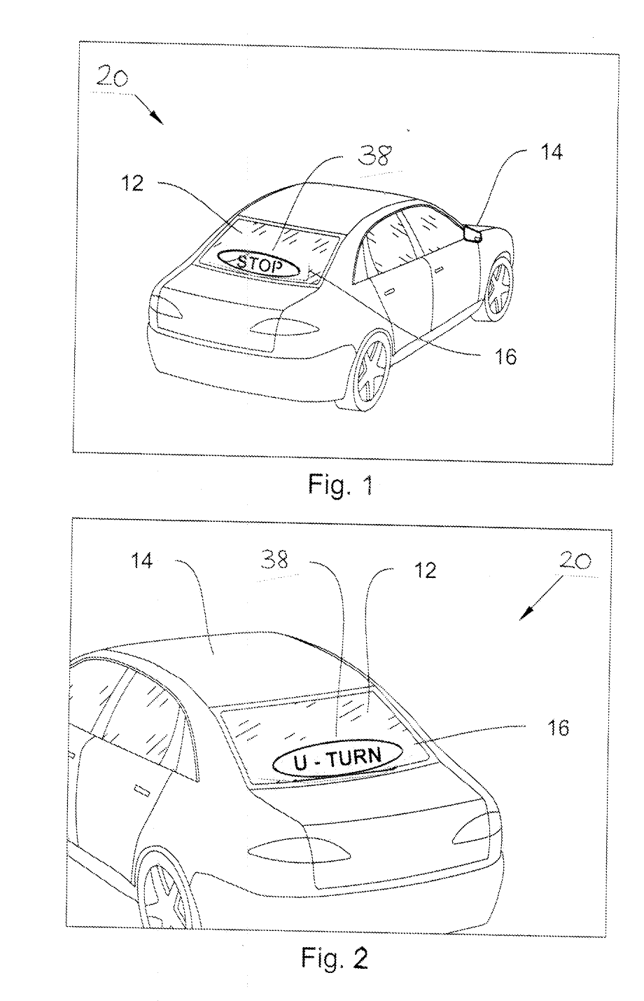

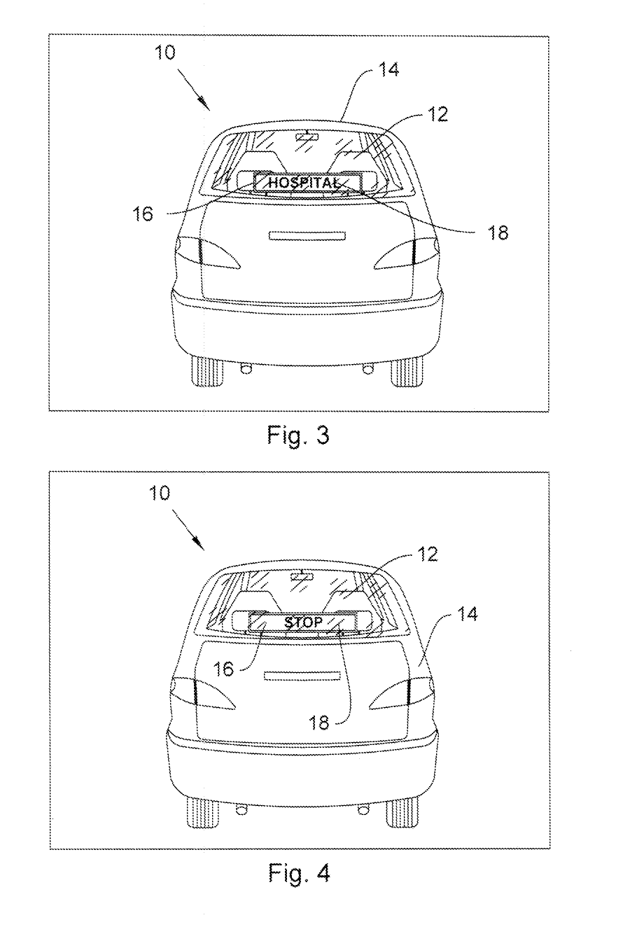

In FIGS. 1 and 2, the Digital Display Screen 20 is shown having an elliptical screen 38. The elliptical screen 38 will help to differentiate the use of the screen by an individual user as opposed to a message generated by an emergency vehicle, law enforcement or public carrier.

In addition, the Digital Display Screen Device 10 or 20 of the present invention can be controlled by operation of controls mounted on the dashboard or other place in the vehicle 14. In this manner, the operation of the Digital Display Screen Device 10 or 20 is within easy reach of the occupants in the vehicle 14 and can be accomplished by anyone sitting in the front seat, or elsewhere depending on the position of the controls, of the vehicle 14.

The aforementioned voice/remote control of the Digital Display Screen Device 10 or 20 of the present invention contains a series of push buttons with individual buttons representing various messages to be displayed on the screen. Once activated, the remote control and sensor mechanism causes a series of bulbs or LEDs located behind the screen 18 of the Digital Display Screen Device 10 or 20 to light up and display the emergency message. The message is boldly emblazoned in bright, block letters which immediately flash across the sign 16, readable from left to right.

In the preferred embodiment, the message is displayed in bright red letters, with any contrasting background. It is also contemplated that any combination of contrasting colors would be suitable for use in the present invention.

Initial messages comprising this display capability include FLAT TIRE, OUT OF GAS, OFFICER ASSISTANCE, U TURN, REVERSE, CAUTION, HOSPITAL, and AMBER ALERT, in addition to others.

The Digital Display Screen Device 10 or 20 of the present invention provides stranded motorists with a safe and efficient means of alerting others to their trouble. When stranded, drivers no longer need to leave their vehicles 14 to seek help in often unsafe conditions. By simply activating the Digital Display Screen Device 10 or 20, drivers project a clear message through their rear window 12 to inform passing motorists of their plight and request help if needed. Whether calling a mechanic, law enforcement or an ambulance, others can assist a stranded driver in a matter that is safe for them as well. The Digital Display Screen Device 10 or 20 functions as a backup for cellular phone owners who experience unserviceable areas, dead batteries or forgotten phones. With this innovative technology incorporated into their vehicle, motorists always are adequately prepared for virtually any roadside emergency or everyday driving situation.

Although this invention has been described with respect to specific embodiments, it is not intended to be limited thereto and various modifications which will become apparent to the person of ordinary skill in the art are intended to fall within the spirit and scope of the invention as described herein taken in conjunction with the accompanying drawings and the appended claims.

1. A digital display screen device for a vehicle, the vehicle having a rear window, the digital display screen device comprising:
an elliptical shaped housing positionable in the rear window of the vehicle;
an elongated screen mounted on the housing and viewable through the rear window of the vehicle, the screen displaying information; and
a control mechanism in communication with the screen for controlling power to and information on the screen;
wherein upon activation of the screen, the information displayed on the screen is a safety indicator or a need for roadside assistance in a critical situation.

2. The digital display screen device of claim 1 wherein the screen is sized and shaped for fitting into the back window of the vehicle.

3. The digital display screen device of claim 1 wherein the information is a written message.

4. The digital display screen device of claim 3 wherein the message displayed on the screen is selected by a user.

5. The digital display screen device of claim 4 wherein the message is preprogrammed.

6. The digital display screen device of claim 5 wherein the message is selected from the group consisting of FLAT TIRE, OUT OF GAS, OFFICER ASSISTANCE, U TURN, REVERSE, CAUTION, HOSPITAL, and AMBER ALERT.

7. The digital display screen device of claim 1 wherein the message is emblazoned in bright, red block letters flashing across the sign, readable from left to right.

8. The digital display screen device of claim 1 wherein the control mechanism is a cordless handheld remote control component.

9. The digital display screen device of claim 1 wherein the control mechanism is voice automated or a remote control component connected by an elongated power cord.

10. The digital display screen device of claim 1 wherein the control mechanism is positionable on a dashboard of the vehicle.

11. The digital display screen device of claim 1 wherein the control mechanism has a series of push buttons with individual buttons representing various messages to be displayed on the screen.

12. A method for communicating from a vehicle, the vehicle having a rear window, the method comprising:
positioning an elliptical housing in the rear window of the vehicle;
mounting an elongated screen on the housing;
viewing the screen through the rear window of the vehicle, the screen displaying information;
providing a control mechanism;
communicating with the screen for controlling power to and information on the screen; and
displaying the information on the screen.

13. A digital display screen device for a vehicle, the vehicle having a rear window, the digital display screen device comprising:
an elliptical housing positionable in the rear window of the vehicle;
an elongated screen mounted on the housing and viewable through the rear window of the vehicle, the screen displaying a message; and
a control mechanism in communication with the screen for controlling power to and message on the screen;
wherein upon activation of the screen, the message displayed on the screen is selected to provide a safety indicator or a need for roadside assistance in a critical situation; and
wherein the message is emblazoned in bright, red block letters flashing across the sign, readable from left to right.

14. The digital display screen device of claim 13 wherein the screen is sized and shaped for fitting into the back window of the vehicle.

15. The digital display screen device of claim 14 wherein the message displayed on the screen is selected by a user.

16. The digital display screen device of claim 15 wherein the message is preprogrammed.

17. The digital display screen device of claim 16 wherein the message is selected from the group consisting of FLAT TIRE, OUT OF GAS, OFFICER ASSISTANCE, U TURN, REVERSE, CAUTION, HOSPITAL, and AMBER ALERT.

18. The digital display screen device of claim 13 wherein the control mechanism is voice automated or a cordless handheld remote control component.

19. The digital display screen device of claim 13 wherein the control mechanism is a remote control component connected by an elongated power cord.

20. The digital display screen device of claim 13 wherein the control mechanism is positionable on a dashboard of the vehicle and has a series of push buttons with individual buttons representing various messages to be displayed on the screen.
